(19) United States
(12) Patent Application Publication
(10) Pub. No.: US 2021/0103162 A1
(43) Pub. Date: Apr. 8, 2021

(54) LENS WITH OPTICAL AREA TO INCREASE DEFOCUS IMAGE AREA

(71) Applicant: BRIGHTEN OPTIX CORP., Taipei (TW)

(72) Inventors: Wen-Pin LIN, Taipei (TW); Ping-Jui CHAN, Taipei (TW)

(21) Appl. No.: 17/125,430

(22) Filed: Dec. 17, 2020

Related U.S. Application Data
(63) Continuation-in-part of application No. 16/158,833, filed on Oct. 12, 2018.

(30) Foreign Application Priority Data
Nov. 17, 2017 (TW) 106217150

(51) Int. Cl. G02C 7/04

(52) U.S. Cl. CPC G02C 7/044; G02C 2202/24; G02C 7/047

(57) ABSTRACT

A lens with an optical area to increase a defocus image refractive powers is disclosed. A central optical zone of the lens includes a non-circular optical area, and a defocus area formed on a part thereof other than the optical area. An outer surface of the peripheral optical zone is aspheric, so that the original space of the central optical zone can be effectively used to increase the defocus image area of the retina of eye ball and light passing the peripheral optical zones can create different amounts of peripheral blurring areas in front of different areas of the retina; this defocusing of the images, providing more controlled amount of myopic defocus to the retina, which acts as a putative cue to slow myopic eye growth.

This application is a Continuation-In-Part of application Ser. No. 16/158,833, filed on Oct. 12, 2018, for which priority is claimed under 35 U.S.C § 120, the entire contents of which are hereby incorporated by reference.

This application claims the priority benefit of Taiwan patent application number 106217150, filed on Nov. 17, 2017.

### BACKGROUND OF THE INVENTION

### 1. Field of the Invention

The present invention relates to a lens with an optical area to increase a defocus image area. More particularly, a central optical zone of the lens includes a non-circular optical area, and a defocus area formed on a part thereof other than the optical area, and an outer surface of a peripheral optical zone of the lens is aspheric, so that the original space of the central optical zone can be effectively used to increase the defocus image area of the retina of eye ball, and the aspheric outer surface is used to effectively control myopia progression, thereby slowing or retarding myopia progression and correcting myopia in children/adolescents optically at the same time.

### 2. Description of the Related Art

Electronic product development connects people's daily lives to technology and enhance lifestyle/convenience. Especially the heavy use of computers, communications, and consumer (3C) electronic products results in the popularization of communication and internet technology applications. Many people immerse themselves in the use of 3C electronic products. Mobile phone overuse is seen among certain office workers, students, middle aged and elderly people. People everywhere are beginning to lose patience with the phenomenon known as phubbing: snubbing others in a social setting by checking your phone. Mobile phone overuse can also lead to vision impairment. The result of King's College London study from 2015, explores the possible link between increased computer and smartphone use and rising rates of myopia.

The general way of correcting myopia is wearing glasses, such as eyeglasses or contact lenses. In configuration of the eyeglass lens or the contact lens for correcting myopia, an inner surface and the outer surface of a central optical zone and a peripheral optical zone of the lens have different curvatures, so that light from an external object can clearly focus on a retina of the eyeball without distortion through the central optical zone, and light passing the peripheral optical zone can focus on a predetermined viewpoint in front of the retina; as a result, the eyeglasses lens or contact lenses can provide a clear image in the center of the visual field of the eye, since the refractive powers of the peripheral optical zone is lower than the refractive power of the central optical zone, thereby slowing or retarding myopia progression, and correct myopia in children/adolescents optically at the same time. The peripheral optical zone of the conventional lens for correcting myopia has a single curvature and a predetermined refractive power lower than the refractive power of the central optical zone, but eyeball and retina are essentially asymmetrical, so the distances from the peripheral optical zone of the eyeglass lens or the contact lens to the retina at different positions are actually not the same.

Therefore, what is needed is to develop myopia control lens to solve the problem that the conventional lens is unable to achieve the desired effect of reducing or retarding myopia progression because the peripheral optical zone of conventional lens cannot fit the position and shape of the wearer's retina.

### SUMMARY OF THE INVENTION

In order to solve the conventional problems, the inventor develops the myopia control lens with an optical area to increase defocus image area, according to collected data, multiple tests and modifications, and years of experience in the industry.

The primary objective of the present invention is that the myopia control lens includes a central optical zone and peripheral optical zones surrounding the central optical zone. The central optical zone includes a non-circular optical area, and a defocus area formed on a part thereof other than the optical area. Varies regions of asymmetric periphery optical zones create different amounts of blur surrounding a central imaging area. The outer peripheral surface consists of different regions and different amounts of asymmetrical aspheric, so that the central optical zone can increase a defocus image area of the retina of the eyeball and light passing the peripheral optical zones can create different amounts of peripheral blurring areas in front of different areas of a retina; this defocusing of the images, providing more controlled amount of myopic defocus to the retina, which acts as a putative cue to slow myopic eye growth. Following animal studies that have demonstrated the strong inhibitory effect of peripheral myopic defocus on axial elongation or myopia develop, it has been hypothesized that inducing myopic retinal defocus may slow or retard the progression of myopia in children. Contact lenses provide the most viable opportunity to beneficially modify genetics and environment factors through their close alignment with the eye and consistent wearing time. The present invention will induce myopic retinal defocus by the asymmetrical aspheric surface of the lens to create different amounts of peripheral defocus in varies regions of the retina, which acts as a putative cue, further, a ciliary muscle can be relaxed by putative cue, so that intraocular lens can become flatter and the light passing the peripheral optical zone can be imaged on the retina, thereby preventing the ciliary muscle of the eyeball from staying at the tight state for a long time and slowing myopic eye growth.

The secondary objective of the present invention is that the inner surface of the myopia control lens is spherical, and the process of fitting and producing the lens can be simpler, thereby achieving the purpose of improving product yield.

### BRIEF DESCRIPTION OF THE DRAWINGS

The structure, operating principle and effects of the present invention will be described in detail by way of various embodiments which are illustrated in the accompanying drawings.

FIG. 1 is a schematic view of optical paths of an embodiment of the present invention.

FIG. 2 is a schematic plan view of myopia control lens of an embodiment of the present invention.

FIG. 3 is a schematic view of process of imaging on retina, according to an embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

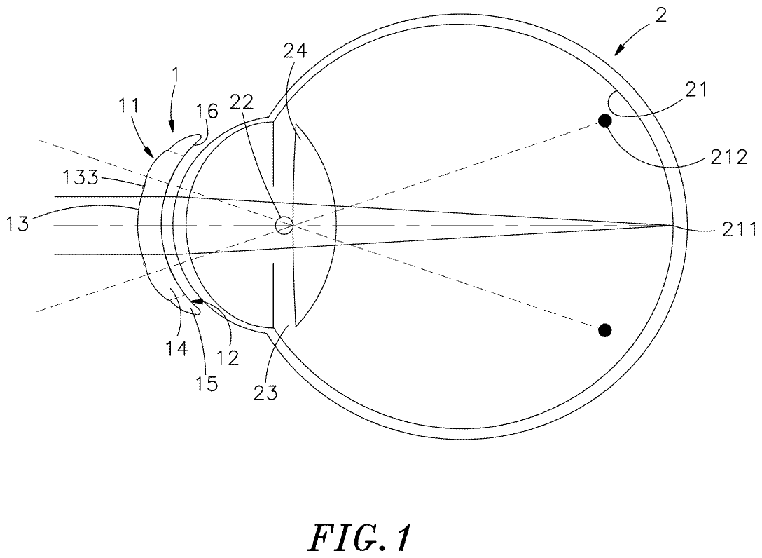

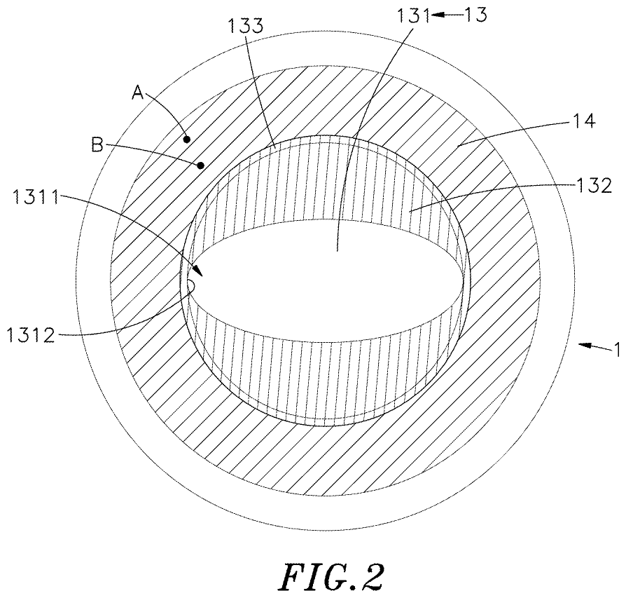

Please refer to FIGS. 1 to 3, which are schematic view of optical paths, a schematic plan view, and a schematic view of process of imaging on retina, according to the present invention. In an embodiment, the myopia control lens 1 can be a lens 1 of a contact lens or the lens 1 of an eyeglass. As shown in FIGS. 1 to 3, the lens 1 comprises an outer surface 11 and an inner surface 12, and a central optical zone 13 is formed on the outer surface 11 and the inner surface 12 and configured to pass light to focus on a central imaging area 211 of a retina 21 of a wearer's eyeball 2. For example, the central imaging area 211 can be the fovea of the retina 21. The central optical zone 13 includes a non-circular optical area 131, and a defocus area 132 formed on a part thereof other than the optical area 131; for example, the optical area 131 can be elliptic. The optical area 131 has convex parts 1311 extended toward periphery of the central optical zone 13 in a horizontal direction, and each convex part 1311 has a circular-arc-shaped corner 1312 formed at an end portion thereof. Furthermore, the lens 1 includes a peripheral optical zone 14 surrounding the central optical zone 13 and configured to pass light to focus on a peripheral blurring area 212 around the central imaging area 211; for example, the peripheral blurring area 212 surrounds the fovea. Furthermore, the lens 1 includes a non-optical zone 15 which is formed around the peripheral optical zone 14, and the plurality of position-limiting grooves 16 formed on the surface thereof and configured to prevent the lens 1 from rotation.

In an embodiment, the inner surface 12 of the lens 1 is spherical, and the outer surface 11 of the central optical zone 13 is aspheric, and the outer surface 11 of the peripheral optical zone 14 is aspheric.

The eccentricity of the outer surface 11 of the peripheral optical zone 14 can vary in different position, that is, the eccentricity of (A) point on the outer surface 11 is different from the eccentricity of (B) point on the outer surface 11, so as to make the outer surface 11 asymmetrical aspheric. In an embodiment, the lens power of the peripheral optical zone 14 of the lens 1 is in a range of 0.00 diopter to −20.00 diopter, and the eccentricity of the peripheral optical zone 14 is in a range of 0 to −1.740.

The eccentricity of the outer surface 11 of the central optical zone 13 must be less than the eccentricity of the outer surface 11 of the peripheral optical zone 14, and the peripheral optical zone 14 can have more relative positive power than the central optical zone 13. Furthermore, the outer surfaces 11 of the central optical zone 13 and the peripheral optical zone 14 can be combined integrally through a joint section 133, and the eccentricity of the joint section 133 is between the eccentricity of the central optical zone 13 and the eccentricity of the peripheral optical zone 14.

Preferably, the optical area 131 and the defocus area 132 of the central optical zone 13 can be formed on the outer surface 11 of the lens 1; in an actual application, the optical area 131 and the defocus area 132 can be formed on the inner surface 12 of the lens 1, or in an embodiment, each of the outer surface 11 and the inner surface 12 is formed with the optical area 131 and the defocus area 132.

The optical area 131 of the central optical zone 13 has convex parts 1311 extended in a horizontal direction, so that that light passing through the convex parts 1311 can clearly image on the retina 21 while eyeball 2 moves in horizontal direction for viewing or browsing. The convex parts 1311 of the optical area 131 can satisfy the wearer's need for clear vision image, for example, during reading, the eyeball 2 moves in the horizontal direction for browsing text, and the convex parts 1311 can meet the need in reading. Furthermore, the other area of the central optical zone 13 through which the wearer does not need clear vision image formed, can be used as the defocus area 132 of the central optical zone 13; for example, the wearer seldom uses the area along non-horizontal direction during reading, so this area can be used as the defocus area 132 to increase the defocus image area. As a result, the area of the optical area of retina 21 with defocus effect can be extended, so that myopia progression can be controlled without the need of excessively increasing the defocus power of the lens 1, and the required defocus power can be reduced, and the possibility that visual performance in central vision field is affected by excessive defocus power can also be reduced.

The refractive powers of the defocus area 132 of the central optical zone 13 and the peripheral optical zone 14 are less than the refractive power of the optical area 131 of the central optical zone 13, so that the lens 1 can have peripheral defocus effect. Preferably, the refractive power of the defocus area 132 is equal to that of the peripheral optical zone 14.

The outer contour of the defocus area 132 of the central optical zone 13 is circular, and the outer contour of the peripheral optical zone 14 is also circular. In a condition that the outer contours of the defocus area 132 and the peripheral optical zone 14 are circular, the defocus area 132 and the peripheral optical zone 14 can have maximal areas, so as to maximize the area of the optical area having defocus effect on retina 21.

In an embodiment, the lens 1 can be contact type, and preferably, the plurality of position-limiting grooves 16 of the contact-type lens 1 can be disposed on peripheral of the inner surface 12 without affecting arrangement of the central optical zone 13 and the peripheral optical zone 14, so as to facilitate processing and formation of the central optical zone 13 and the peripheral optical zone 14; in actual application, the plurality of position-limiting grooves 16 can be disposed on the outer surface 11 of the lens 1, or each of the outer surface 11 and the inner surface 12 is formed with the plurality of position-limiting grooves 16. In an embodiment, in order to form the plurality of position-limiting grooves 16, an upper edge and a lower edge of the inner surface 12 can be cut to be thinner, so as to form position-limiting grooves (not shown in figures) on the upper edge and the lower edge, respectively, so that the lens 1 can be positioned on the eyeball 2 by the plurality of position-limiting grooves and be prevented from rotation. It should be noted that there are various manners or structures useful for aligning the lens 1 to the eyeball 2, so numerous modifications, variations and enhancements can be made thereto by those skilled in the art without departing from the spirit and scope of the disclosure set forth in the claims. In an embodiment, the lens 1 can be spectacles, and the plurality of position-limiting grooves 16 can be a frame to wear to locate the lens 1 on the wearer's face.

In order to correct myopia, that is, the axial length of the user's eyeball 2 is too long, the user can wear the myopia control lens 1 first, light passing the central optical zone 13 of the lens 1 can focus on the central imaging area 211 of the retina 21 of the eyeball 2, and light passing the peripheral optical zone 14 of the lens 1 can focus in front of the peripheral blurring area 212 of the retina 21 because the peripheral optical zone 14 has relative positive power than the central optical zone 13 and the asymmetrical aspheric of the outer surface 11 of the peripheral optical zone 14; at this time, light passing the peripheral optical zone 14 of the lens 1 can focus in front of the peripheral blurring area 212 of the retina 21 and can be used for defocusing the image and provide myopic defocus to the retina, which acts as a putative cue, further, a ciliary muscle 23 can be relaxed by putative cue, so that intraocular lens 24 can become flatter and the light passing the peripheral optical zone 14 can be imaged on the retina 21, thereby preventing the ciliary muscle 23 of the eyeball 2 from staying at the tight state for a long time and slowing myopic eye growth.

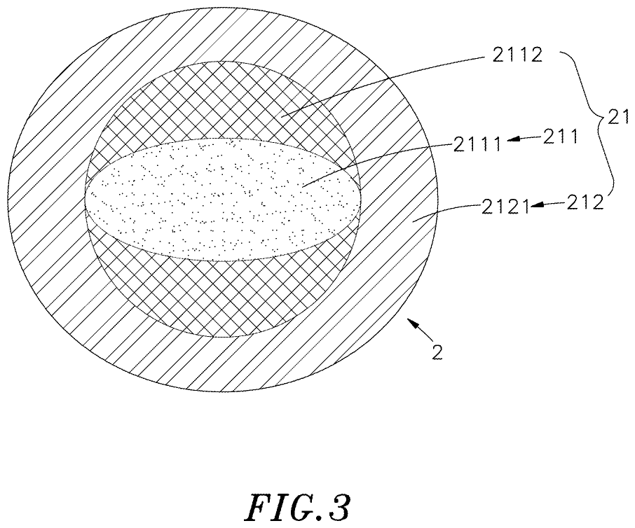

When the lens 1 is worn on eyeball 2, the lens 1 can be aligned to the eyeball 2 by the plurality of position-limiting grooves 16, so as to prevent the lens 1 from easily rotating on the eyeball 2. The light passing the peripheral optical zone 14 can image on the peripheral image blurring area 212 of retina 21 to form the first defocus image 2121, as shown in FIG. 3; and when light passes the central optical zone 13, the light passing the optical area 131 of the central optical zone 13 images on the central imaging area 211 of retina 21 to form a clear image 2111, and the light passing the defocus area 132 of the central optical zone 13 images on the area of the central imaging area 211 other than the clear image 2111, to form a second defocus image 2112. As a result, the defocus area 132 can be used to increase entire defocus image area of retina 21.

When the wearer's eyeball 2 moves in horizontal direction for browsing external object, the clear image 2111 can be formed on the central imaging area 211 through the convex parts 1311 on the optical area 131, so that the wearer can clearly view external object in horizontal direction; furthermore, the light passing the defocus area 132 forms the second defocus image 2112 which can be used to increase the defocus image area, thereby increasing the area of the optical area of retina 21 with defocus effect. By using the lens of the present invention, myopia progression can be controlled without the need for excessively increasing the defocus power of the lens 1, so as to reduce the required defocus power of the lens, and also reduce possibility that the visual performance in central vision field is affected by excessive defocus power. As a result, the defocus area 132 with lower refractive power (more ADD) can be used for defocusing the image and provide myopic defocus to the retina, which acts as a putative cue to slow myopic eye growth.

The inner surface 12 of the lens 1 is spherical, so the process of fitting and producing the lens 1 can be simpler, thereby achieving the effect of improving product yield.

The above-mentioned content is merely for illustration of preferred embodiment of the present invention, the scope of claim of the present invention is not limited thereto. The main concept of the present invention is that the central optical zone 13 of the lens 1 includes the non-circular optical area 131, and the defocus area 132 formed on the part of the central optical zone 13 other than the central optical zone 13, so that the original space of the central optical zone 13 can be used to increase the defocus image area of retina 21 of eyeball 2; the outer surface 11 of the peripheral optical zone 14 is aspheric, and the aspheric outer surface 11 can be used to effectively control myopia, and effectively slow myopia progression optically, thereby achieving effect of correcting myopia. It should be noted that various equivalent structural changes, alternations or modifications based on the descriptions and figures of present invention to achieve aforementioned effect, are all consequently viewed as being embraced by the spirit and the scope of the present disclosure set forth in the claims.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A lens with optical area to increase defocus image area, comprising:
an outer surface;
an inner surface;
a central optical zone formed on the outer surface and the inner surface and configured to pass light to clearly focus on a central imaging area of a retina of eyeball; and
peripheral optical zones surrounding the central optical zone and configured to pass light to focus on a peripheral blurring area around the central imaging area, wherein the peripheral optical zones include aspheric outer surfaces configured to pass light to focus in front of the peripheral blurring area of the retina; and
a plurality of position-limiting grooves formed on the surface of the lens and configured to prevent the myopia control lens from rotating;
wherein the central optical zone comprises an optical area and a defocus area, and the optical area is formed on a surface of the central optical zone and configured to pass light to clearly focus on the central imaging area of the retina of the eyeball, and the defocus area is formed on a part of the surface of the central optical zone other than the optical area and configured to increase defocus image area of the central imaging area;
wherein eccentricity of the outer surface of the central optical zone is less than eccentricity of the outer surfaces of the peripheral optical zones.

2. The lens with optical area to increase defocus image area according to claim 1, wherein the lens is a lens of a contact lens or a lens of an eyeglass.

3. The lens with optical area to increase defocus image area according to claim 1, wherein the inner surface is spherical.

4. The lens with optical area to increase defocus image area according to claim 1, wherein the outer surface of the central optical zone is aspheric.

5. The lens with optical area to increase defocus image area according to claim 1, further comprising a non-optical zone surrounding the peripheral optical zone.

6. The lens with optical area to increase defocus image area according to claim 1, wherein the lens power of the peripheral optical zone is in range of 0.00 diopter to −20.00 diopter, and the eccentricity of the peripheral optical zone is in range of 0 to −1.740.

7. The lens with optical area to increase defocus image area according to claim 1, further comprising a joint section jointed between the outer surfaces of the central optical zone and the peripheral optical zone, and eccentricity of the joint section is between the eccentricity of the outer surface of the central optical zone and the eccentricity of the outer surface of the peripheral optical zone.

8. The lens with optical area to increase defocus image area according to claim 1, wherein the optical area of the central optical zone is elliptic.

9. The lens with optical area to increase defocus image area according to claim 1, wherein the optical area and the defocus area of the central optical zone are formed on the outer surface of the lens.

10. The lens with optical area to increase defocus image area according to claim 1, wherein the optical area and the defocus area of the central optical zone are formed on the inner surface of the lens.

11. The lens with optical area to increase defocus image area according to claim 1, wherein each of the outer surface and the inner surface is formed with the optical area and the defocus area.

12. The lens with optical area to increase defocus image area according to claim 1, wherein the optical area has a plurality of convex parts extended in horizontal direction.

13. The lens with optical area to increase defocus image area according to claim 12, wherein the plurality of convex parts of the optical area are extended to periphery of a central optical zone.

14. The lens with optical area to increase defocus image area according to claim 1, wherein each of a plurality of convex parts of the optical area has a circular-arc-shaped corner.

15. The lens with optical area to increase defocus image area according to claim 1, wherein refractive powers of the defocus area of the central optical zone and the peripheral optical zone are lower than refractive power of the optical area, and the refractive power of the defocus area is equal to the refractive power of the peripheral optical zone.

16. The lens with optical area to increase defocus image refractive powers according to claim 1, wherein the plurality of position-limiting grooves is formed on an edge of the inner surface.
